(19) United States
(12) Patent Application Publication
(10) Pub. No.: US 2020/0269350 A1
(43) Pub. Date: Aug. 27, 2020

(54) NOZZLE UNIT FOR LASER PROCESSING

(71) Applicant: HK CO., LTD., Hwaseong-si (KR)

(72) Inventors: Hyo Sang KIM, Pyeongtaek-si (KR); Hyun Woo YANG, Seoul (KR); Won Jae LEE, Hwaseong-si (KR)

(73) Assignee: HK CO., LTD., Hwaseong-si (KR)

(21) Appl. No.: 16/667,861

(22) Filed: Oct. 29, 2019

(30) Foreign Application Priority Data
Feb. 22, 2019 (KR) 10-2019-0021136

(51) Int. Cl. B23K 26/14; B23K 26/12

(52) U.S. Cl. CPC B23K 26/1482; B23K 26/1476; B23K 26/123; B23K 26/1494

(57) ABSTRACT

Disclosed is a nozzle unit for laser processing, which can implement one-touch coupling and separation, thereby enabling easy nozzle replacement and uniform maintenance of a nozzle in a mounted state at an accurate position while preventing damage to a nozzle joint. The nozzle unit for laser processing includes: a nozzle body including a nozzle hole and a coupling protrusion formed at an outer periphery of the nozzle hole; and a nozzle adapter allowing the nozzle body to be inserted into and coupled to a lower portion thereof and including a nozzle coupling portion allowing the coupling protrusion at a first position to be inserted thereinto or separated therefrom and allowing the coupling protrusion at a second position to be seated thereon, the second position being spaced apart from the first position in a circumferential direction of the nozzle hole.

### FIELD

The present invention relates to a nozzle unit for laser processing, and, more particularly, to a nozzle unit for laser processing which allows easy replacement of a nozzle used in a laser processing apparatus.

### BACKGROUND

A laser processing apparatus is an apparatus that processes a workpiece by focusing laser beams emitted from a laser beam generator via a laser processing head, followed by irradiation of the workpiece with the focused laser beams through a nozzle disposed at a lower end of the laser processing head.

Among processing methods using such a laser processing apparatus, laser cutting is a process that focuses laser beams from a laser beam generator at a minute spot on a surface of a workpiece using a lens or a mirror and cuts the workpiece by melting and evaporating the workpiece by spraying an appropriate assist gas while moving the workpiece or the laser beams.

In order to accurately and effectively direct the laser beams and the assist gas to the workpiece, the laser processing head is coupled at a lower end thereof to a nozzle having an orifice-type nozzle hole. Such a nozzle may be replaced depending upon the types of workpieces or processing conditions, as well as after long-term use.

Conventionally, the nozzle and the laser processing head have a female thread and a male thread, respectively, such that the nozzle is mounted on the laser processing head by being screwed onto the laser processing head. However, this feature has a problem of inconvenience in installation and replacement.

In addition, the nozzle is likely to be displaced after long-term use due to wear of the threaded portions, thereby causing processing failure due to difficulty in directing the laser beams or the assist gas to an exact target region.

Further, if mount failure occurs at a joint between the laser processing head and the nozzle, there is considerable inconvenience upon replacement of the nozzle with a new one.

Moreover, the nozzle is likely to contact a workpiece or a surrounding structure during laser processing or upon movement for replacement, thereby causing damage to the joint between the laser processing head and the nozzle.

Furthermore, if the laser processing head is secured to the nozzle by a direct coupling method, such as thread engagement, when the nozzle contacts a workpiece or a surrounding structure during laser processing or upon movement for replacement, the contact load is completely transferred to the laser processing head, thereby causing dislocation of an optical system disposed at the laser processing head, thus resulting in failure of laser beam irradiation.

In addition, upon replacing a used nozzle with a new one in the nozzle changer, precise control over relative positions between the laser processing head and the nozzle changer is required for coupling the new nozzle to the laser processing head by thread engagement, which is accompanied by increase in complexity of a mechanical structure of the nozzle changer and a control program therefor and increase in costs.

### SUMMARY

Embodiments of the present invention have been conceived to overcome such a problem in the art and it is an aspect of the present invention to provide a nozzle unit for laser processing, which can implement one-touch coupling and separation, thereby enabling easy nozzle replacement and uniform maintenance of a nozzle in a mounted state at an accurate position while preventing damage to a nozzle joint.

In accordance with one aspect of the present invention, a nozzle unit for laser processing includes: a nozzle body including a nozzle hole and a coupling protrusion formed at an outer periphery of the nozzle hole; and a nozzle adapter allowing the nozzle body to be inserted into and coupled to a lower portion thereof and comprising a nozzle coupling portion allowing the coupling protrusion at a first position to be inserted thereinto or separated therefrom and allowing the coupling protrusion at a second position to be seated thereon, the second position being spaced apart from the first position in a circumferential direction of the nozzle hole.

The nozzle unit may further include: a sleeve member slidably disposed in the nozzle adapter and including a flange facing the coupling protrusion coupled to the nozzle coupling portion; and an elastic member disposed between the nozzle adapter and the sleeve member and pushing the flange to press the coupling protrusion against the nozzle coupling portion.

The nozzle coupling portion may include: an annular protrusion protruding inwardly of the nozzle adapter and formed at an upper surface thereof with a flat support; a through-groove formed on an inner circumferential surface of the annular protrusion to allow the coupling protrusion to pass therethrough; and a seating portion circumferentially spaced apart from the through-groove and allowing the coupling protrusion moving along the flat support to be seated thereon.

The seating portion may be concave corresponding to the coupling protrusion.

The nozzle unit may further include an inclined guide portion formed at a top edge of the coupling protrusion or at a bottom edge of the through-groove to guide coupling between the through-groove and the coupling protrusion.

Upon movement between the first position and the second position, the coupling protrusion may be spaced apart from the flat support to avoid friction with the flat support.

The coupling protrusion may be formed at a lower portion thereof with a curved portion convex downwards and the seating portion may have a shape corresponding to the curved portion to allow the curved portion to be tightly seated thereon.

The nozzle unit may further include: a first sealing member disposed between the nozzle body and the sleeve member to hermetically seal a boundary between the nozzle body and the sleeve member; and a second sealing member disposed between the nozzle adapter and the elastic member to hermetically seal a boundary between the nozzle adapter and the sleeve member.

The nozzle adapter may include: a first nozzle adapter formed at an upper end thereof with a head coupling portion coupled to a laser processing head of a laser processing apparatus, formed at a lower end thereof with a first nozzle adapter coupling portion, and formed at an inside thereof with a first through hole; and a second nozzle adapter formed at an upper end thereof with a second nozzle adapter coupling portion coupled to the first nozzle adapter coupling portion, formed at a lower end thereof with the nozzle coupling portion, and formed at an inside thereof with a second through-hole communicating with the first through-hole.

The sleeve member may be slidably supported at upper and lower ends thereof on an inner surface of the nozzle adapter to remain coaxial with the nozzle hole.

Here, the sleeve member may be slidably supported at the upper end thereof on the first through-hole and at the lower end thereof on the second through-hole to remain coaxial with the nozzle hole.

The upper end of the sleeve member may remain inserted into the first through-hole after the flange is moved downward and pressed against the nozzle body by resilient force of the elastic member.

The present invention provides a nozzle unit for laser processing, which can implement substantially one-touch coupling/separation of a nozzle body to/from a nozzle adapter, thereby allowing easy and quick nozzle replacement.

In addition, according to the present invention, the nozzle body has constant coupling force with respect to the nozzle adapter through an elastic member, thereby allowing uniform maintenance of a nozzle in a mounted state at an accurate position and preventing damage to a joint between the nozzle adapter and the nozzle body.

Further, according to the present invention, since the nozzle body has constant coupling force with respect to the nozzle adapter through the elastic member, the nozzle can effectively absorb shock when contacting a workpiece or a surrounding structure during laser processing or upon movement for replacement, thereby preventing problems, such as damage to a joint between the nozzle adapter and a laser processing head and dislocation of an optical system disposed at the laser processing head.

Furthermore, according to the present invention, since the nozzle unit allows easy nozzle replacement, it is possible to simplify a mechanical structure of an existing nozzle changer and a control program therefor, thereby providing cost reduction.

Furthermore, according to the present invention, since the nozzle unit allows rapid nozzle replacement and a replaced new nozzle can be uniformly maintained in place, thereby allowing improvement in laser processing efficiency.

### DRAWINGS

FIG. 1 is a perspective view of a nozzle unit for laser processing according to the present invention.

FIG. 2 is an exploded perspective view of the nozzle unit for laser processing according to the present invention.

FIG. 3 is a view illustrating a process of coupling a nozzle body to a nozzle adapter according to the present invention.

FIG. 4 is a view illustrating insertion/separation/seating of a coupling protrusion into/from/on a nozzle coupling portion according to the present invention.

FIG. 5 is a sectional view of the nozzle unit for laser processing according to the present invention.

FIG. 6 is a view illustrating coupling of the coupling protrusion to a through-groove and a seating portion of the nozzle coupling portion according to the present invention.

### DETAILED DESCRIPTION

Hereinafter, embodiments of the present invention will be described with reference to the accompanying drawings. It should be noted that like components will be denoted by like reference numerals throughout the specification and the accompanying drawings. In addition, descriptions of details apparent to those skilled in the art will be omitted for clarity.

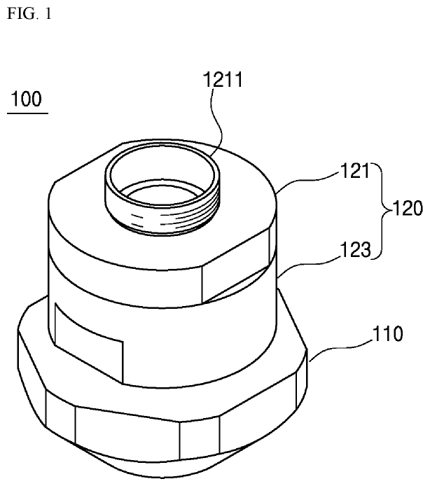

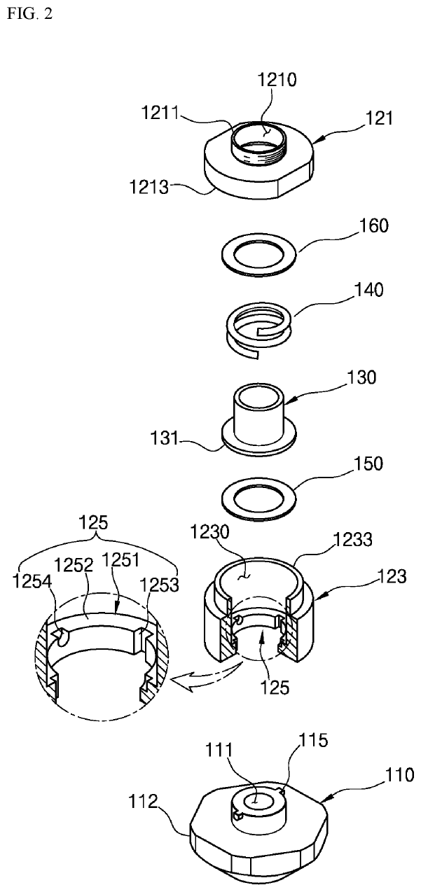

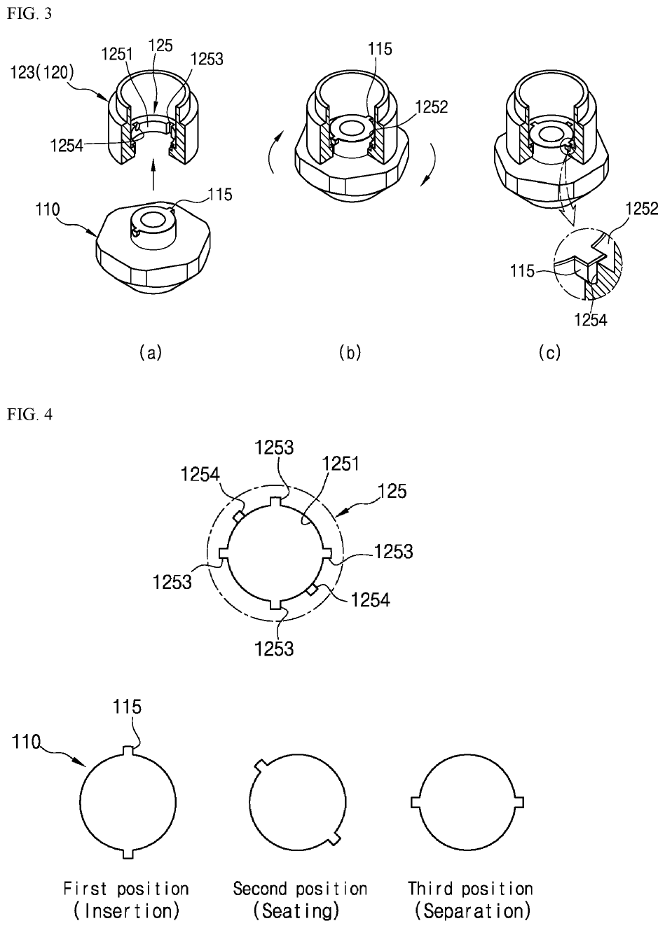

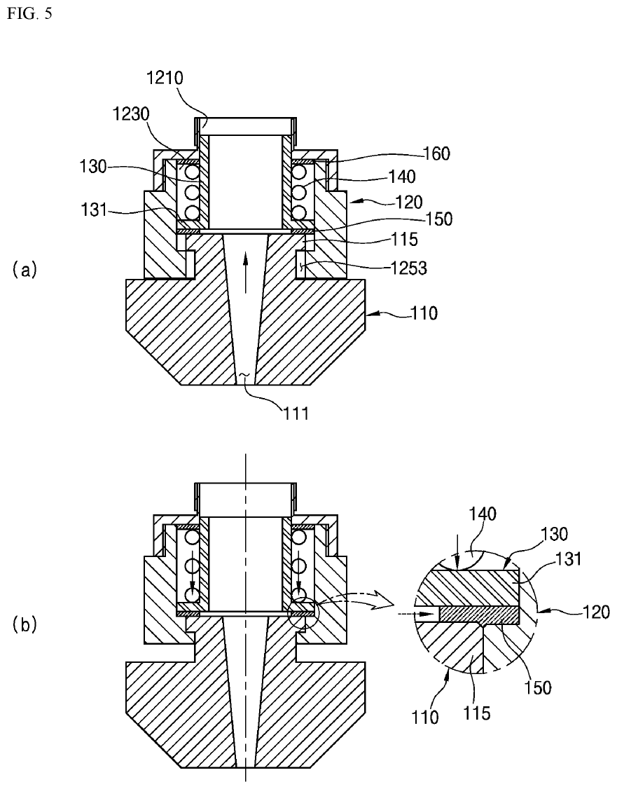

FIG. 1 is a perspective view of a nozzle unit for laser processing according to the present invention, FIG. 2 is an exploded perspective view of the nozzle unit for laser processing according to the present invention, FIG. 3 is a view illustrating a process of coupling a nozzle body to a nozzle adapter according to the present invention, FIG. 4 is a view illustrating insertion/separation/seating of a coupling protrusion into/from/on a nozzle coupling portion according to the present invention, and FIG. 5 is a sectional view of the nozzle unit for laser processing according to the present invention.

Referring to FIG. 1 to FIG. 5, a nozzle unit 100 for laser processing according to the present invention includes a nozzle body 110 and a nozzle adapter 120.

The nozzle body 110 is a component that is replaced depending on types of workpieces or processing conditions, and includes a nozzle hole 111 allowing laser beams and an assist gas to pass therethrough and a coupling protrusion 115 formed at an outer periphery of the nozzle hole 111.

The nozzle hole 111 may have an orifice structure.

The coupling protrusion 115 may be formed at an upper periphery of the nozzle body to protrude outwardly of the nozzle hole 111 and may include a plurality of coupling protrusions arranged at predetermined intervals along the outer periphery of the nozzle hole 111. For example, two coupling protrusions may be arranged at intervals of 180 degrees, as shown in the drawings. Alternatively, four coupling protrusions may be arranged at intervals of 90 degrees, or six coupling protrusions may be arranged at intervals of 60 degrees. That is, the coupling protrusion 115 may include two or more coupling protrusions 115 arranged at equidistant intervals in a circumferential direction of the nozzle hole 111.

In one embodiment, an upper end of the nozzle body 110 may be inserted into and coupled to the nozzle adapter 120 described below and a lower end of the nozzle body 110 may be formed with a grip portion 112 for applying torque to the nozzle body 110. The grip portion 112 may have a shape suitable for being clamped by an external clamping device such as a nozzle changer, for example, a bolt-head shape.

The nozzle adapter 120 connects the nozzle body 110 to a laser processing head (not shown) of a laser processing apparatus to direct laser beams and an assist gas supplied through the laser processing head to the nozzle hole 111 of the nozzle body 110. In addition, an upper end of the nozzle adapter 120 is coupled to the laser processing head of the laser processing apparatus and a lower end of the nozzle adapter 120 allows the nozzle body 110 to be inserted thereinto and coupled thereto.

The nozzle adapter 120 includes a nozzle coupling portion 125.

The nozzle coupling portion 125 allows the coupling protrusion 115 at a first position to be inserted thereinto or separated therefrom and allows the coupling protrusion 115 at a second position to be seated thereon and locked in position, wherein the second position is spaced apart from the first position in the circumferential direction of the nozzle hole 111.

Here, the first position may be at least one position having a different turn angle than the second position in a circumferential direction of the nozzle coupling portion 125.

Likewise, the second position may be at least one position having a different turn angle than the first position in the circumferential direction of the nozzle coupling portion 125.

That is, the first position and the second position are positions spaced apart from each other in the circumferential direction of the nozzle coupling portion 125, that is, positions not overlapping each other, rather than each being one specific point (location).

In other words, each of the first position and the second position may be defined by one or more positions varying depending on the number and arrangement interval of coupling protrusions 115 and the number and arrangement interval of through-grooves 1253 or seating portions 1254 described below.

In one embodiment, the nozzle coupling portion 125 may be disposed at the lower end of the nozzle adapter 120 and may include an annular protrusion 1251, a through-groove 1253, and a seating portion 1254.

The annular protrusion 1251 protrudes inwardly of the nozzle adapter 120 and is formed at an upper surface thereof with a flat support 1125. The annular protrusion 1251 protrudes to an extent that the nozzle adapter can have an insertion hole large enough to receive the upper end of the nozzle body 110 formed with the coupling protrusion 115.

The through-groove 1253 is vertically formed on an inner surface of the annular protrusion 1251 to be open at the top and bottom thereof and is allowing the coupling protrusion 115 to pass therethrough.

The through-groove 1253 may include two through-grooves arranged at intervals of 180 degrees, four through-grooves arranged at intervals of 90 degrees, or six through-grooves arranged at intervals of 60 degrees to correspond in number and interval to the coupling protrusion 115. Alternatively, the number of through-grooves 1253 may be larger than that of coupling protrusions 115. For example, when two coupling protrusions 115 are arranged at intervals of 180 degrees, four through-grooves 1253 may be arranged at intervals of 90 degrees.

The seating portion 1254 is formed on the flat support 1252 to allow the coupling protrusion 115 moving along the flat support 1252 to be seated thereon and is circumferentially spaced apart from the through-groove 1253.

As shown in the drawings, the seating portion 1254 may have a concave shape corresponding to the coupling protrusion 115.

As shown the drawings, the seating portions 1254 may correspond in number and interval to the coupling protrusions 115. Alternatively, the number of seating portions 1254 may be larger than that of coupling protrusions 115. For example, when two coupling protrusions 115 are arranged at intervals of 180 degrees, four seating portions 1254 may be arranged at intervals of 90 degrees.

FIG. 4 is a schematic plan view illustrating insertion/separation/seating (coupling) of the coupling protrusion into/from/on the nozzle coupling portion according to one embodiment of the present invention.

In the embodiment of FIG. 4, the nozzle body 110 includes two coupling protrusions 115 arranged at intervals of 180 degrees and the nozzle coupling portion 125 includes four through-grooves 1253 arranged at intervals of 90 degrees and two seating portions 1254 arranged at intervals of 180 degrees.

That is, the coupling protrusions 115 may be inserted into respective selected through-grooves 1253 vertically aligned therewith among the plural through-grooves 1253 (the first position). After passing through the selected through-grooves 1253, the coupling protrusions 115 may be seated on respective seating portions 1254 by being circumferentially moved by external force (the second position). In addition, after being separated from the seating portions 1254 by external force, the coupling protrusions 115 may be removed from the nozzle adapter through the other two respective through-grooves by being circumferentially moved (the third position).

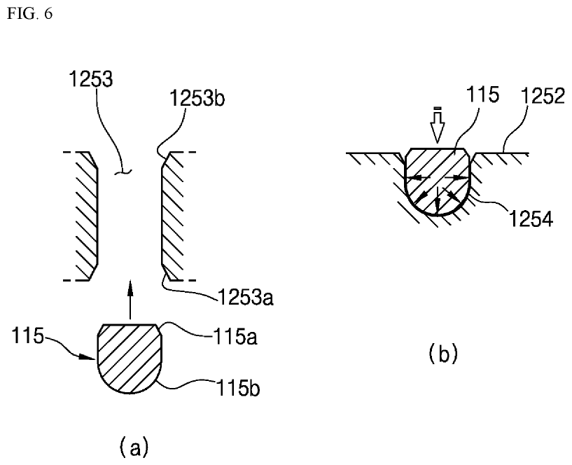

Referring to FIG. 6(a), the coupling protrusion 115 may be formed at a top edge thereof with an inclined guide portion 115a inclined toward an end thereof.

In addition, the through-groove 1253 may be formed at a bottom edge thereof with an inclined guide portion 1253a inclined toward an end thereof.

The inclined guide portion 115a, 1253a may be formed at the top edge of the coupling protrusion 115 and/or at the bottom edge of the through-groove 1253.

The inclined guide portion 115a, 1253a serves to guide initial insertion of the coupling protrusion 115 in the process of coupling the coupling protrusion 115 to the through-groove 1253. For example, even when the coupling protrusion 115 and the through-groove 1253 vertically moving relative to each other are slightly misaligned, insertion of the coupling protrusion 115 into the through-groove 1253 can be quickly achieved so long as a degree of misalignment falls within an extension range of the inclined guide portion 115a, 1253a.

In addition, the through-groove 1253 may be further formed at a top edge thereof with an inclined guide portion 1253b and the coupling protrusion 115 may be further formed at a bottom edge thereof with an inclined guide portion. That is, upon separating the nozzle body 110 from the nozzle adapter, the coupling protrusion 115 moving along the flat support 1252 can be quickly inserted into the through-groove 1253 by the inclined guide portions.

Referring to FIG. 6(b), the coupling protrusion 115 may be formed at a lower portion thereof with a curved portion 115b convex downward, and the seating portion 1254 may have a curved shape corresponding to the curved portion 115b of the coupling protrusion 115 to allow the curved portion 115b to be tightly seated thereon.

Since the lower end of the coupling protrusion 115 is curved, friction between the flat support 1252 and the coupling protrusion moving along the flat support can be reduced, thereby allowing smooth movement of the coupling protrusion. In addition, upon entering the seating portion 1254, the coupling protrusion 115 can be quickly inserted into and coupled to the seating portion 1254 due to weight of the nozzle body 110 and resilient force of an elastic member 140 described below.

Upon moving the coupling protrusion 115 between the first position and the second position, that is, upon turning the nozzle body 110, the coupling protrusion 115 may be upwardly spaced apart from the flat support 1252, rather than rubbing against the flat support 1252.

That is, the coupling protrusion 115 may be spaced apart from the flat support 1252 by pushing the nozzle body 110 upwards such that the elastic member 140 described below is contracted. Thus, upon turning the nozzle body 110 in a forward or reverse direction, friction between the coupling protrusion 115 and the flat support 1252 can be avoided. As a result, it is possible to prevent generation of fine dust due to friction, thus preventing contamination of the laser beams or the assist gas.

In addition, since respective surfaces of the seating portion 1254 and the coupling protrusion 115 seated against each other are curved, vertical resilient force transferred from the elastic member 140 disposed thereon generates uniform dispersion force in all directions of the seated surfaces, thereby allowing reduction in vibration of the nozzle body 110, such as shaking, and allowing the nozzle body to be securely held in position.

Further, since the respective surfaces of the seating portion 1254 and the coupling protrusion 115 seated against each other are curved, even when the nozzle body 110 is subjected to vertical or oblique impact during laser processing or upon movement for replacement, the nozzle body 110 can effectively absorb shock of the impact.

In one embodiment, the nozzle adapter 120 may include a first nozzle adapter 121 and a second nozzle adapter 123.

The first nozzle adapter 121 may include a head coupling portion 1211, a first nozzle adapter coupling portion 1213, and a first through-hole 1210.

More specifically, the first nozzle adapter 121 is formed at an upper end thereof with the head coupling portion 1211 coupled to the laser processing head of the laser processing apparatus, formed at a lower end thereof with the first nozzle adapter coupling portion 1213, and formed at an inside thereof with the first through-hole 1210.

Each of an outer circumferential surface of the head coupling portion 1211 and an inner circumferential surface of the first nozzle adapter coupling portion 1213A may be threaded.

The second nozzle adapter 123 may include the nozzle coupling portion 125, a second nozzle adapter coupling portion 1233, and a second through-hole 1230.

More specifically, the second nozzle adapter 123 is formed at an upper end thereof with the second nozzle adapter coupling portion 1233 coupled to the first nozzle adapter coupling portion 1213, formed at a lower end thereof with the nozzle coupling portion 125, and formed at an inside thereof with the second through-hole 1230 communicating with the first through-hole 1210.

An outer circumferential surface of the second nozzle adapter coupling portion 1233 may be threaded.

The second through-hole 1230 may have a larger diameter than the first through-hole 1210, and a region adjacent to an inner circumferential surface of the second through-hole 1230 may provide a space for installation of a sleeve member 130, the elastic member 140, a first sealing member 150, and a second sealing member 160 described below.

That is, the first nozzle adapter 121 and the second nozzle adapter 123 may form the nozzle adapter 120 by screwing the first nozzle adapter coupling portion 1213 onto the second nozzle adapter coupling portion 1233. In addition, with the first nozzle adapter 121 separated from the second nozzle adapter 123, assembly and disassembly of the sleeve member 130, the elastic member 140, the first sealing member 150, and the second sealing member 160 described below can be facilitated.

The nozzle unit 100 for laser processing according to the present invention may further include the sleeve member 130.

The sleeve member 130 may be slidably disposed inside the nozzle adapter 120 and may include a flange 131 facing the coupling protrusion 115 coupled to the nozzle coupling portion 125.

Here, the sleeve member 130 may be slidably supported at upper and lower ends thereof on an inner surface of the nozzle adapter 120 to remain coaxial with the nozzle hole 111. A sealing member described below may be disposed at the upper and lower ends of the sleeve member 130 slidingly contacting the nozzle adapter 120.

For example, the sleeve member 130 may be slidably supported at the upper end thereof on the first through-hole 1210 of the first nozzle adapter 121 and at the lower end thereof on the second through-hole 1230 of the second nozzle adapter 123 to remain coaxial with the nozzle hole 111. More specifically, an outer circumferential surface of the upper end of the sleeve member 130 is supported on an inner circumferential surface of the first through-hole 1210 of the first nozzle adapter 121, and an outer edge of the flange 131 formed at the lower end of the sleeve member 130 is supported on an inner circumferential surface of the second through-hole 1233.

After the flange portion 131 is pressed against the nozzle body 110 by being moved downward by resilient force of the elastic member 140 described below, the upper end of the sleeve member 130 may remain inserted into the first through-hole 1210.

Although not shown in the drawings, respective inner circumferential surfaces of the first through-hole 1210 and the second through-hole 1230 may be coupled to respective outer circumferential surfaces of the upper and lower ends of the sleeve member 130 by spline engagement.

Since the upper and lower ends of the sleeve member 130 remain firmly in contact with the inner circumferential surface of the nozzle adapter 120, the sleeve member 130 operatively associated with coupling/separation of the nozzle body 110 can remain stably coaxial with the nozzle hole 111.

The nozzle unit 100 for laser processing according to the present invention may further include the elastic member 140.

The elastic member 140 is disposed between the nozzle adapter 120 and the sleeve member 130 and pushes the flange portion 131 to press the coupling protrusion 115 against the nozzle coupling portion 125.

In one embodiment, the elastic member 140 may be a coil spring and may be disposed on the inner circumferential surface of the second through-hole 1230 of the second nozzle adapter 123 such that an upper end thereof faces a stepped surface of the first nozzle adapter 121 and a lower end thereof faces the nozzle coupling portion 125 of the nozzle adapter 120. The elastic member 140 is contracted by coupling the first nozzle adapter 121 to the second nozzle adapter 123.

Upon assembling the nozzle adapter 120, the sleeve member 130, the elastic member 140, the first sealing member 150, and the second sealing member 160, the first sealing member 150, the sleeve member 130, the elastic member 140, and the second sealing member 160 are sequentially inserted into the second through-hole 1230 of the second nozzle adapter 123, and then the second nozzle adapter coupling portion 1233 of the second nozzle adapter 123 is screwed onto the first nozzle adapter coupling portion 1213 of the first nozzle adapter 121, whereby the elastic member 140 is contracted to: downwardly push the flange 131 to press the first sealing member 150 against the nozzle coupling portion 125; and upwardly push the second sealing member 160 against the stepped portion of the first nozzle adapter 121.

The nozzle unit 100 for laser processing according to the present invention may further include a sealing member.

The sealing member may include a first sealing member 150 and a second sealing member 160.

The first sealing member 150 may be disposed between the nozzle body 110 and the sleeve member 130 to hermetically seal a boundary between the nozzle body 110 and the sleeve member 130.

Referring to FIG. 5 in detail, the first sealing member 150 may be disposed between the annular protrusion 1251 of the nozzle coupling portion 125 and the flange 131 of the sleeve member 130 with the nozzle body 110 removed from the nozzle adapter, and may hermetically seal a boundary between the annular protrusion 1251 and the coupling protrusion 115 and a boundary between the flange 131 and the nozzle adapter 120 with the nozzle body 110 coupled to the nozzle adapter.

For example, the first sealing member 150 serving to hermetically seal the boundary between the annular protrusion 1251 and the coupling protrusion 115 and the boundary between the flange 131 and the nozzle adapter 120 may be formed of a rubber or thermally expandable resin that can apply strong reaction force as a shape thereof changes due to resilient force of the elastic member 140 and pressure of an assist gas toward the nozzle hole 111.

The second sealing member 160 may be disposed between the nozzle adapter 120 and the elastic member 140 to hermetically seal a boundary between the nozzle adapter 120 and the sleeve member 130. Although not shown in the drawings, a washer member may be interposed between the elastic member 140 and the second sealing member 160.

For example, the second sealing member 160 serving to hermetically seal the boundary between the sleeve member 130 and the nozzle adapter 120 may be any sealing member having good frictional durability, such as an engineering seal.

Next, a process of replacing the nozzle unit 100 for laser processing according to the present invention will be described.

In order to couple the nozzle body 110 to the nozzle adapter 120, first, the coupling protrusion 115 of the nozzle body 110 is vertically aligned with the through-groove 1253 of the nozzle coupling portion 125 (the first position). See FIG. 3(a).

With the coupling protrusion 115 vertically aligned with the through-groove 1253 to be inserted into the through-groove (the first position), the nozzle body 110 is moved upwards to overcome resilient force of the elastic member 140, thereby allowing the coupling protrusion 115 to pass through the through-groove 1253. See FIG. 3(b).

Then, the nozzle body 110 is turned in a forward or reverse direction, whereby the coupling protrusion 115 is moved along the flat support 1252 until reaching the seating portion 1254. Upon reaching the seating portion 1254, the coupling protrusion 115 is naturally pressed against and seated onto the seating portion 1254 by resilient force of the elastic member 140 (the second position). In this way, the nozzle body 110 can be quickly coupled to the nozzle adapter. See FIG. 3(c).

When the nozzle body 110 is mounted on the nozzle adapter, since the coupling protrusion 115 of the nozzle body 110 can remain seated on the seating portion 1254 of the nozzle adapter 120 by resilient force of the elastic member 140, the nozzle hole 111 can remain precisely and uniformly maintained in place.

In addition, when the nozzle body 110 is mounted on the nozzle adapter, since the nozzle body 100 can absorb shock when contacting a workpiece or a surrounding structure during laser processing or in the course of being moved for nozzle replacement, it is possible to prevent problems such as damage to a joint between the nozzle adapter 120 and the laser processing head and dislocation of an optical system disposed at the laser processing head.

On the other hand, in order to separate the nozzle body 110 from the nozzle adapter 120, first, the nozzle body 110 mounted on the nozzle adapter 120 is pushed upward to overcome resilient force of the elastic member 140, whereby the coupling protrusion 115 of the nozzle body 110 is easily separated from the seating portion 1254. See FIG. 5(a).

Then, the nozzle body 110 is turned in the forward or reverse direction, whereby the coupling protrusion 115 is moved along the flat support 1252 until reaching the through-groove 1253. Upon reaching the through-groove 1253, the coupling protrusion 115 downwardly passes through and leaves the through-groove 1253 by resilient force of the elastic member 140 (the third position). In this way, the nozzle body 110 can be quickly separated from the nozzle adapter.

As a result, an operator can easily and quickly separate the nozzle body 110 from the nozzle adapter with little effort.

According to the present invention, upon performing nozzle replacement using a nozzle changer, coupling/separation of the nozzle body 110 to/from the nozzle adapter 120 is simplified, thereby allowing simplification of a mechanical structure of the nozzle changer and a control program therefor.

For example, for a typical nozzle structure employing thread engagement, a nozzle changer requires a servomotor capable of satisfying precise control and rpm requirements and a plurality of cushioning members for absorbing a shock to a nozzle. However, according to the present invention, since it is sufficient to set a minimum turn angle, a linear drive unit, such as a cylinder, can be employed, thereby allowing structural downsizing and cost reduction.

In addition, for the typical nozzle structure, a step of examining the precision of concentricity of the nozzle hole 111 is required after replacement with a new nozzle using a nozzle changer and prior to an actual processing process. However, according to the present invention, since a possibility of misconnection can be eliminated, the aforementioned step can be omitted, thereby enabling more efficient laser processing.

Although some embodiments have been described herein, it should be understood that these embodiments are provided for illustration only and are not to be construed in any way as limiting the present invention, and that various modifications, changes, alterations, and equivalent embodiments can be made by those skilled in the art without departing from the spirit and scope of the invention.

What is claimed is:

1. A nozzle unit for laser processing, comprising:
a nozzle body comprising a nozzle hole and a coupling protrusion formed at an outer periphery of the nozzle hole; and
a nozzle adapter allowing the nozzle body to be inserted into and coupled to a lower portion thereof and comprising a nozzle coupling portion allowing the coupling protrusion at a first position to be inserted thereinto or separated therefrom and allowing the coupling protrusion at a second position to be seated thereon, the second position being spaced apart from the first position in a circumferential direction of the nozzle hole.

2. The nozzle unit for laser processing according to claim 1, further comprising:
a sleeve member slidably disposed in the nozzle adapter and comprising a flange facing the coupling protrusion coupled to the nozzle coupling portion; and
an elastic member disposed between the nozzle adapter and the sleeve member and pushing the flange to press the coupling protrusion against the nozzle coupling portion.

3. The nozzle unit for laser processing according to claim 1, wherein the nozzle coupling portion comprises:
an annular protrusion protruding inwardly of the nozzle adapter and formed at an upper surface thereof with a flat support;
a through-groove formed on an inner circumferential surface of the annular protrusion to allow the coupling protrusion to pass therethrough; and
a seating portion circumferentially spaced apart from the through-groove and allowing the coupling protrusion moving along the flat support to be seated thereon.

4. The nozzle unit for laser processing according to claim 3, wherein the seating portion is concave corresponding to the coupling protrusion.

5. The nozzle unit for laser processing according to claim 3, further comprising:
an inclined guide portion formed at a top edge of the coupling protrusion or at a bottom edge of the through-groove to guide coupling between the through-groove and the coupling protrusion.

6. The nozzle unit for laser processing according to claim 3, wherein, upon movement between the first position and the second position, the coupling protrusion is spaced apart from the flat support to avoid friction with the flat support.

7. The nozzle unit for laser processing according to claim 3, wherein the coupling protrusion is formed at a lower portion thereof with a curved portion convex downwards and the seating portion has a shape corresponding to the curved portion to allow the curved portion to be tightly seated thereon.

8. The nozzle unit for laser processing according to claim 2, further comprising:
a first sealing member disposed between the nozzle body and the sleeve member to hermetically seal a boundary between the nozzle body and the sleeve member; and
a second sealing member disposed between the nozzle adapter and the elastic member to hermetically seal a boundary between the nozzle adapter and the sleeve member.

9. The nozzle unit for laser processing according to claim 2, wherein the nozzle adapter comprises:
a first nozzle adapter formed at an upper end thereof with a head coupling portion coupled to a laser processing head of a laser processing apparatus, formed at a lower end thereof with a first nozzle adapter coupling portion, and formed at an inside thereof with a first through hole; and
a second nozzle adapter formed at an upper end thereof with a second nozzle adapter coupling portion coupled to the first nozzle adapter coupling portion, formed at a lower end thereof with the nozzle coupling portion, and formed at an inside thereof with a second through-hole communicating with the first through-hole.

10. The nozzle unit for laser processing according to claim 2, wherein the sleeve member is slidably supported at upper and lower ends thereof on an inner surface of the nozzle adapter to remain coaxial with the nozzle hole.

11. The nozzle unit for laser processing according to claim 9, wherein the sleeve member is slidably supported at the upper end thereof on the first through-hole and at the lower end thereof on the second through-hole to remain coaxial with the nozzle hole.

12. The nozzle unit for laser processing according to claim 9, wherein the upper end of the sleeve member remains inserted into the first through-hole after the flange is moved downward and pressed against the nozzle body by resilient force of the elastic member.
